(19) United States
(12) Patent Application Publication
(10) Pub. No.: US 2026/0216901 A1
(43) Pub. Date: Jul. 30, 2026

(54) ROBOT JOINT STRUCTURE AND ROBOT

(71) Applicant: KAWASAKI JUKOGYO KABUSHIKI KAISHA, Kobe-shi, Hyogo (JP)

(72) Inventors: So YUKIZAKI, Kobe-shi (JP); Yuki TANAKA, Kobe-shi (JP); Masayuki KAMON, Kobe-shi (JP)

(73) Assignee: KAWASAKI JUKOGYO KABUSHIKI KAISHA, Kobe-shi, Hyogo (JP)

(21) Appl. No.: 19/144,710

(22) PCT Filed: Dec. 27, 2023
(86) PCT No.: PCT/JP2023/046950

§ 371 Date: Jun. 30, 2025

(30) Foreign Application Priority Data
Dec. 28, 2022 (JP) 2022-211805

(51) Int. Cl. B25J 17/00; B62D 57/02

(52) U.S. Cl. CPC B25J 17/00; B62D 57/02

(57) ABSTRACT

A joint structure of a robot includes a first link mechanism configured rotatably about a first axis and is rotatably connected to a first frame and an end of a first linear actuator; and a second link mechanism configured rotatably about the first axis and is rotatably connected to the first frame and the end of the second linear actuator.

### TECHNICAL FIELD

The present disclosure relates to a robot joint structure and a robot.

### BACKGROUND ART

Robot joint structures are disclosed in the art. Japanese Patent Laid-Open Publication No. JP 2013-91145 discloses a robot joint structure including a first member and a second member rotating relative to the first member about a first axis and a second axis perpendicular to each other. The joint structure includes a support member supporting the first member rotatably about the first axis. Also, the second member rotates relative to the support member about the second axis. Also, the joint structure includes a pair of linear actuators arranged between the first member and the second member and connected to the first member and the second member. The pair of linear actuators are arranged from the first member over the second member. The second member is rotated relative to the first member about the first axis when the pair of linear actuators extend/retract together by the same amount. Also, the second member is rotated relative to the first member about the second axis when the pair of linear actuators extend/retract together by the same amount in different extension/retraction directions.

### PRIOR ART

### Patent Document

Patent Document 1: Japanese Patent Laid-Open Publication No. JP 2013-91145

### SUMMARY OF THE INVENTION

In the robot joint structure stated in Japanese Patent Laid-Open Publication No. JP 2013-91145, the linear actuators are arranged from the first member over the second member. Accordingly, each linear actuator must be relatively long, which results in a larger actuator size. As a result, the joint structure becomes larger, and this increase in size may lead to a problem.

The present disclosure is intended to solve the above problem, and one object of the present disclosure is to provide a robot joint structure and a robot capable of preventing an increase in size.

A robot joint structure according to a first aspect of the present disclosure includes a first frame and a second frame; a support that rotatably supports the second frame about a first axis, the support being rotatably supported by the first frame about a second axis perpendicular to the first axis; a first linear actuator and a second linear actuator, each of which having one end connected to a corresponding one of both sides of the second frame and another end operating to extend/retract; a first link mechanism that is configured rotatably about the first axis and is rotatably connected to the first frame and the another end of the first linear actuator; and a second link mechanism that is configured rotatably about the first axis and is rotatably connected to the first frame and the another end of the second linear actuator.

In the robot joint structure according to the first aspect of the present disclosure, as discussed above, a first link mechanism that is configured rotatably about the first axis and is rotatably connected to the first frame and the another end of the first linear actuator, and a second link mechanism that is configured rotatably about the first axis and is rotatably connected to the first frame and the another end of the second linear actuator are provided. Accordingly, because the first linear actuator and the second linear actuator are connected through the first link mechanism and the second link mechanism, respectively, to the first frame, the first linear actuator and the second linear actuator can be connected through the first link mechanism and the second link mechanism, respectively, to the first frame without being arranged from the first frame over the second frame. For this reason, the first linear actuator and the second linear actuator can be made smaller. Consequently, an increase in the size of the robot joint structure can be prevented.

A robot according to a second aspect of the present disclosure includes a joint structure that forms at least one of a waist joint, a neck joint or a wrist joint, wherein the joint structure includes a first frame and a second frame, a support that rotatably supports the second frame about a first axis, the support being rotatably supported by the first frame about a second axis perpendicular to the first axis, a first linear actuator and a second linear actuator, each of which having one end connected to a corresponding one of both sides of the second frame and another end operating to extend/retract, a first link mechanism that is configured rotatably about the first axis and is rotatably connected to the first frame and the another end of the first linear actuator, and a second link mechanism that is configured rotatably about the first axis and is rotatably connected to the first frame and the another end of the second linear actuator.

In the robot according to the second aspect of the present disclosure, as discussed above, a first link mechanism that is configured rotatably about the first axis and is rotatably connected to the first frame and the another end of the first linear actuator, and a second link mechanism that is configured rotatably about the first axis and is rotatably connected to the first frame and the another end of the second linear actuator are provided. Accordingly, because the first linear actuator and the second linear actuator are connected through the first link mechanism and the second link mechanism, respectively, to the first frame, the first linear actuator and the second linear actuator can be connected through the first link mechanism and the second link mechanism, respectively, to the first frame without being arranged from the first frame over the second frame. For this reason, the first linear actuator and the second linear actuator can be made smaller. Consequently, it is possible to provide a robot capable of preventing an increase in the size of the robot joint structure.

According to the present disclosure, an increase in the size of the robot joint structure can be prevented.

### BRIEF DESCRIPTION OF THE DRAWINGS

FIG. 1 is a perspective view showing a humanoid robot according to one embodiment.

FIG. 2 is a view showing a waist joint in an upright posture according to the one embodiment.

FIG. 3 is a schematic view showing the waist joint as viewed from a lateral side according to the one embodiment.

FIG. 4 is a plan view showing a first link mechanism according to the one embodiment.

FIG. 5 is a view showing the waist joint in a posture inclined forward according to the one embodiment.

FIG. 6 is a view showing the waist joint rotated counterclockwise according to the one embodiment.

FIG. 7 is a view showing the waist joint rotated clockwise according to the one embodiment.

FIG. 8 is a view showing the waist joint inclined forward and rotated counterclockwise according to the one embodiment.

### MODES FOR CARRYING OUT THE INVENTION

The following description will describe one embodiment embodying the present disclosure with reference to the drawings. Here, in this specification, the upward/downward direction is defined as a Z direction. An upward direction is defined as a Z1 direction, and a downward direction is defined as a Z2 direction. A direction perpendicular to the Z direction is defined as an X direction. One side in the X direction is defined as an X1 side, and another side is defined as an X2 side. A direction perpendicular to the Z direction and the X direction is defined as a Y direction. One side in the Y direction is defined as a Y1 side, and another side is defined as a Y2 side. Here, the Y1 side corresponds to the front side of a humanoid robot 100.

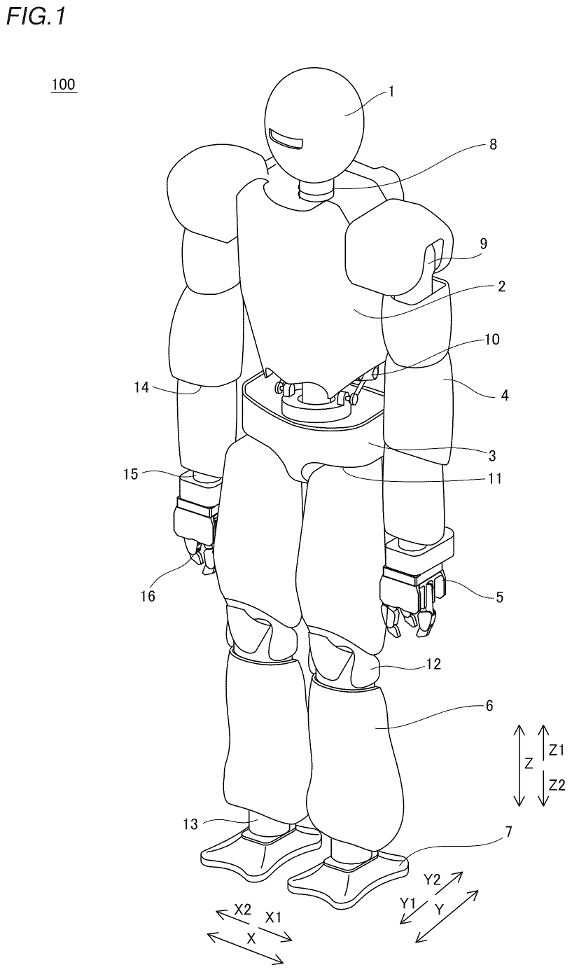

The following description describes a configuration of the humanoid robot 100 according to an embodiment with reference to FIG. 1. The humanoid robot 100 is also referred to as a humanoid. Here, the humanoid robot 100 is an example of a robot.

As shown in FIG. 1, the humanoid robot 100 includes a head 1, an upper torso 2, a lower torso 3, arms 4, hands 5, legs 6, and feet 7. In addition, the humanoid robot 100 includes a neck joint 8, shoulder joints 9, a waist joint 10, hip joints 11, knee joints 12, ankle joints 13, elbow joints 14, wrist joints 15 and finger joints 16. The waist joint 10 is an example of a joint structure.

The head 1 and the upper torso 2 are flexibly connected to each other through the neck joint 8. Accordingly, the head 1 can bend forward, bend backward, and rotate leftward/rightward relative to the upper torso 2. Here, the head 1 may laterally bend relative to the upper torso 2.

The upper torso 2 and the lower torso 3 are flexibly connected to each other through the waist joint 10. Accordingly, the upper torso 2 can bend forward, bend backward, and rotate leftward/rightward relative to the lower torso 3. The lower torso 3 corresponds to a human pelvis. Here, the upper torso 2 may laterally bend relative to the lower torso 3.

The arms 4 includes the elbow joints 14. The arms 4 bend as the elbow joints 14 bend.

The hands 5 are arranged on ends of the arms 4. The hands 5 are connected to the arms 4 through the wrist joints 15. The hands 5 includes the finger joints 16.

The legs 6 include knee joints 12. Also, the legs 6 bend as the knee joints 12 bend.

The arms 4 are connected to the upper torso 2 through the shoulder joints 9. The legs 6 are connected to the lower torso 3 through the hip joints 11. The legs 6 are connected to the feet 7 through the ankle joints 13.

The aforementioned joints include electric motors to drive the joints. The humanoid robot 100 performs bending and turning movements by driving the joints with the electric motors.

### Waist Joint

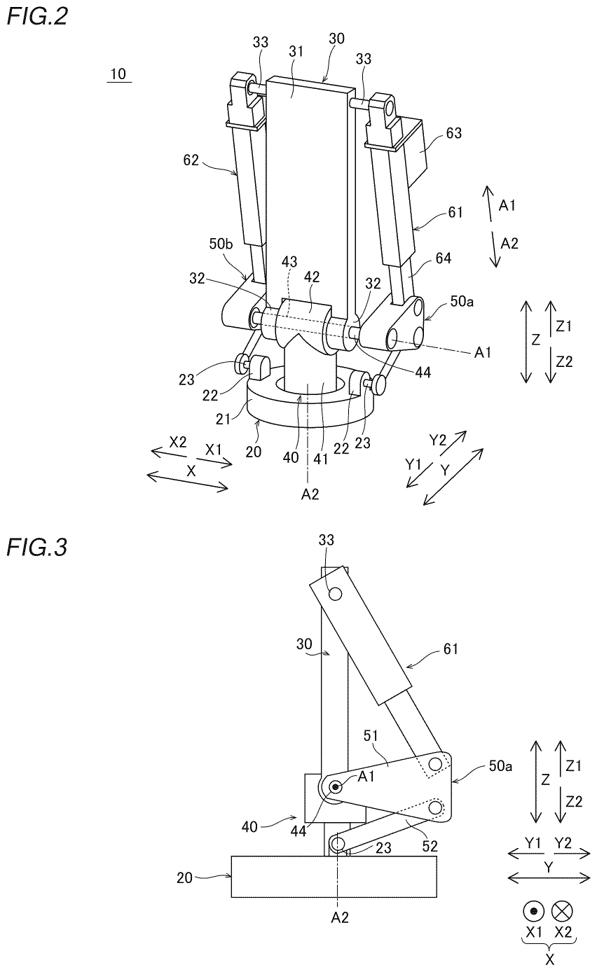

A particular configuration of the waist joint 10 is described. As shown in FIG. 2, the waist joint 10 includes a first frame 20, a second frame 30, a support 40, a first link mechanism 50a, a second link mechanism 50b, a first linear actuator 61, and a second linear actuator 62. The waist joint 10 rotates the second frame 30 relative to the first frame 20 about a pitch axis A1 and a yaw axis A2. The following description describes the configuration of the waist joint 10 in its orientation along an X-Z plane, with the second frame 30 not inclined relative to the first frame 20.

The first frame 20 includes a first part 21 and second parts 22. The first part 21 has a roughly circular shape. The second parts 22 are arranged as a pair. The pair of second parts 22 are oriented parallel to the pitch axis A1. Also, the pair of second parts 22 are arranged on both sides of the yaw axis A2. The pair of second parts 22 protrude from the first part 21 toward a Z1 side. Each shaft 23 is arranged on a side surface of a corresponding one of the pair of second parts 22, and extends in the X1 or X2 direction from that side surface. Here, the pair of shafts 23 may be arranged on opposite sides on an outer peripheral side surfaces of the first part 21 and extend in the X1 and X2 directions without the second part 22. Also, the pair of second parts 22 may not be arranged on the both sides of the yaw axis A2. For example, the pair of second parts 22 may be arranged parts on the Y2 side with respect to the yaw axis A2. Also, the pair of second parts 22 may be arranged parts on the Y1 side with respect to the yaw axis A2.

The second frame 30 includes a first part 31 and second parts 32. The first part 31 has a roughly flat plate shape. The second parts 32 are arranged on a Z2 side of the first part 31 and have roughly cylindrical shapes. The second parts 32 are arranged as a pair. Each shaft 33 is arranged on the Z1 side of a corresponding one of side surfaces of the first part 31, and extends in the X1 or X2 direction from that side surface. Also, the support 40 includes a shaft 44 extending in the X direction and passing through the second part 42. The pair of second parts 32 are connected to the shaft 44 via bearings. The shaft 44 protrudes in the X1 direction from the side surface of one of the pair of second parts 32, and in the X2 direction from the side surface of another of the pair of second parts 32. Here, the shaft 44 may be implemented as separate shafts on the X1 and X2 sides of the second part 42. The above description refers to an exemplary shaft 44 included in the support 40; however, the shaft 44 may instead be included in the second frame 30.

The support 40 rotatably supports the second frame 30 about the pitch axis A1, which extends in the X direction. Also, the support 40 is rotatably supported by the first frame 20 about the yaw axis A2, which extends in the Z direction perpendicular to the X direction. Here, the pitch axis A1 and the yaw axis A2 are examples of a first axis and a second axis, respectively. Specifically, the support 40 includes a first part 41 and a second part 42. The first part 41 has a roughly cylindrical shape and is oriented in the Z direction. The second part 42 has a roughly cylindrical shape and is oriented in the X direction. The second part 42 is arranged between the pair of second parts 32 of the second frame 30. The second part 42 has a hole 43 formed in it, extending in the X direction. The shaft 44 is inserted into the hole 43 of the second part 42. Accordingly, the second frame 30 can rotate relative to the support 40 about the pitch axis A1.

Here, the shapes of the first frame 20, the second frame 30, and the support 40 are not limited to the aforementioned shapes.

Here, the first link mechanism 50a and the second link mechanism 50b according to this embodiment are arranged on both X-directional sides of the second frame 30. The first link mechanism 50a is configured rotatably about the pitch axis A1 and is rotatably connected to the first frame 20 and another end of the first linear actuator 61. The second link mechanism 50b is arranged rotatably about the pitch axis A1 and is rotatably connected to the first frame 20 and another end of the second linear actuator 62. Specifically, the first link mechanism 50a is arranged on the X1-direction side of the second frame 30, and the second link mechanism 50b is arranged on the X2-direction side of the second frame 30. The first link mechanism 50a and the second link mechanism 50b are rotatably connected to the shaft 23 of the first frame 20, and are rotatably connected to the shaft 44.

In this embodiment, each of the first linear actuator 61 and the second linear actuator 62 has one end connected to a corresponding one of both sides of the second frame 30 and another end operating to extend/retract. Specifically, on the X1 side of the second frame 30, the one end of the first linear actuator 61 is rotatably connected to the second frame 30, and the another end of the first linear actuator is connected to the first frame 20 through the first link mechanism 50a. On the X1 side of the second frame 30, the one end of the first linear actuator 61 is rotatably connected to the shaft 33 of the second frame 30, and the another end of the first linear actuator is rotatably connected to the first link mechanism 50a.

Also, on the X2 side of the second frame 30, the one end of the second linear actuator 62 is rotatably connected to the second frame 30, and the another end of the first linear actuator is connected to the first frame 20 through the second link mechanism 50b. On the X2 side of the second frame 30, the one end of the second linear actuator 62 is rotatably connected to the shaft 33 of the second frame 30, and the another end of the first linear actuator is rotatably connected to the second link mechanism 50b.

The first linear actuator 61 includes an electric motor 63 and a rod 64. A ball screw and a gear head (not shown) are arranged on a proximal end side of the rod 64. The rod 64 is moved in the A1 or A2 direction through the gear head rotated by the electric motor 63. Accordingly, the first linear actuator 61 extends/retracts. The first linear actuator 61 and the second linear actuator 62 have the same configuration. Here, the configuration of the first linear actuator 61 and the second linear actuator 62 is not limited to the aforementioned configuration.

In this embodiment, as shown in FIG. 3, the first link mechanism 50a includes a first link 51 and a second link 52. One end of the first link 51 is rotatably connected to the shaft 44. One end of the second link 52 is rotatably connected to the first link 51, and another end of the second link is rotatably connected to the first frame 20. The one end of the first linear actuator 61 is rotatably connected to the second frame 30, and the another end of the first linear actuator is rotatably connected to another end of the first link 51. Specifically, the one end of the first link 51 is rotatably connected to the shaft 44. The one end of the second link 52 is rotatably connected to the first link 51, and the another end of the second link is rotatably connected to the shaft 23 of the first frame 20. Also, the first link 51 has a roughly triangular prism shape. Here, the shape of the first link 51 is not limited to the roughly triangular prism shape. For example, the first link 51 may have a roughly V shape. Also, the second link 52 has a roughly bar shape. Here, the shape of the second link 52 is not limited to the roughly bar shape. Also, a configuration of the second link mechanism 50b is identical to the configuration of the first link mechanism 50a.

Also, in this embodiment, each of the first linear actuator 61 and the second linear actuator 62 is connected to a part on the another end of the first link 51 away from the first frame 20. The second link 52 is connected to a part on the another end of the first link 51 closer to the first frame 20. Specifically, as described above, the first link 51 has the roughly triangular prism shape. The first link 51, more specifically, the part of the first link 51 in proximity to its Y1-side vertex is rotatably connected to the shaft 44. In addition, the first link 51, more specifically, the part of the first link 51 in proximity to its Z1-side vertex is rotatably connected to the another end of the first linear actuator 61. In addition, the first link 51, more specifically, the part of the first link 51 in proximity to its Z2-side vertex is rotatably connected to the one end of the second link 52. Here, the second link mechanism 50b has a configuration similar to the link mechanism 50.

Also, bearings are arranged between the support 40 and the first frame 20. The bearings support the support 40 rotatably relative to the first frame 20.

### Configuration of Link Mechanism

A particular configuration of the first link mechanism 50a is now described. Here, a configuration of the second link mechanism 50b has a configuration similar to the first link mechanism 50a, and its description is omitted.

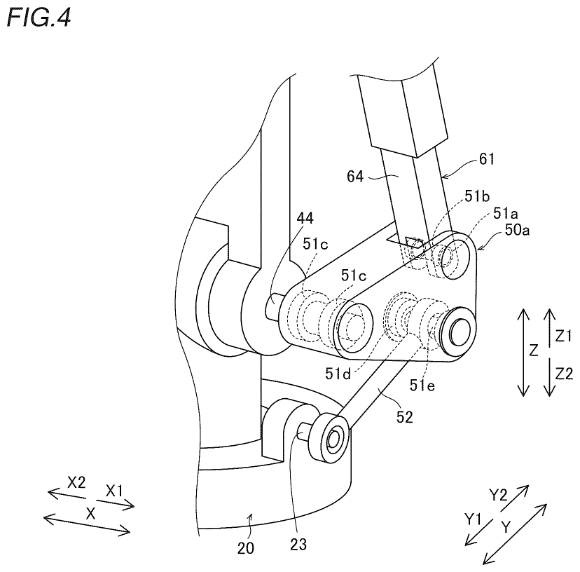

As shown in FIG. 4, the first linear actuator 61 is connected to the first link 51 through rolling bearings 51a. As shown in FIG. 4, the rolling bearings 51a are arranged in the first link 51 as a pair. The pair of rolling bearings 51a are connected by the shaft 51b. A hole 61a is formed in the another end of the first linear actuator 61, and the shaft 51b is inserted into the hole 61a. Here, the rolling bearings 51a may be arranged in the first linear actuator 61.

As shown in FIG. 4, the first frame 20 is connected to the first link 51 through rolling bearings 51c. The rolling bearings 51c are arranged in the first link 51 as a pair. The shaft 44 of the first frame 20 is inserted into the pair of rolling bearings 51c. When the second frame 30 is oriented in an upright posture extending in the Z direction as shown in FIG. 3, the height position of the rolling bearings 51a is above the height position of the rolling bearings 51c. Here, the relation between the height position of the rolling bearings 51a and the height position of the rolling bearings 51c is not limited to the aforementioned relation.

As shown in FIG. 4, the first link 51 is connected to the second link 52 through rolling bearings 51d. The rolling bearings 51d are arranged in the first link 51 as a pair. The pair of rolling bearings 51d are connected by a shaft 51e. A spherical joint is provided at the one end of the second link 52. At the one end of the second link 52, a socket is arranged whose inner surface is in spherical contact with a ball provided on the shaft 51e. The shaft 51e is press-fitted into the ball. When the second frame 30 is oriented in an upright posture extending in the Z direction as shown in FIG. 3, the height position of the shaft 51e is bellow the height position of the rolling bearings 51c. Here, the relation between the height position of the shaft 51e and the height position of the rolling bearings 51c is not limited to the aforementioned relation.

Also, a spherical joint is provided at the another end of the second link 52. At the one end of the second link 52, a socket is arranged whose inner surface is in spherical contact with a ball provided on the shaft 23 of the first frame 20. The shaft 23 of the first frame 20 is press-fitted into the ball.

### Operation of Waist Joint

The operation of the waist joint 10 is now described. In this embodiment, as shown in FIG. 5, the second frame 30 is rotated relative to the first frame 20 about the pitch axis A1 by extending the first linear actuator 61 and the second linear actuator 62 by the same length. Specifically, the second frame 30 is rotated toward a C1 side about the pitch axis A1 by extending the first linear actuator 61 and the second linear actuator 62 by the same length, starting from the orientation along the X-Z plane of the second frame 30 shown in FIG. 2. Correspondingly, the upper torso 2 of the humanoid robot 100 is inclined forward. Also, the second frame 30 is rotated toward a C2 side about the pitch axis A1 by retracting the first linear actuator 61 and the second linear actuator 62 by the same length, starting from the orientation along the X-Z plane of the second frame 30 shown in FIG. 2. Correspondingly, the upper torso 2 of the humanoid robot 100 is inclined backward.

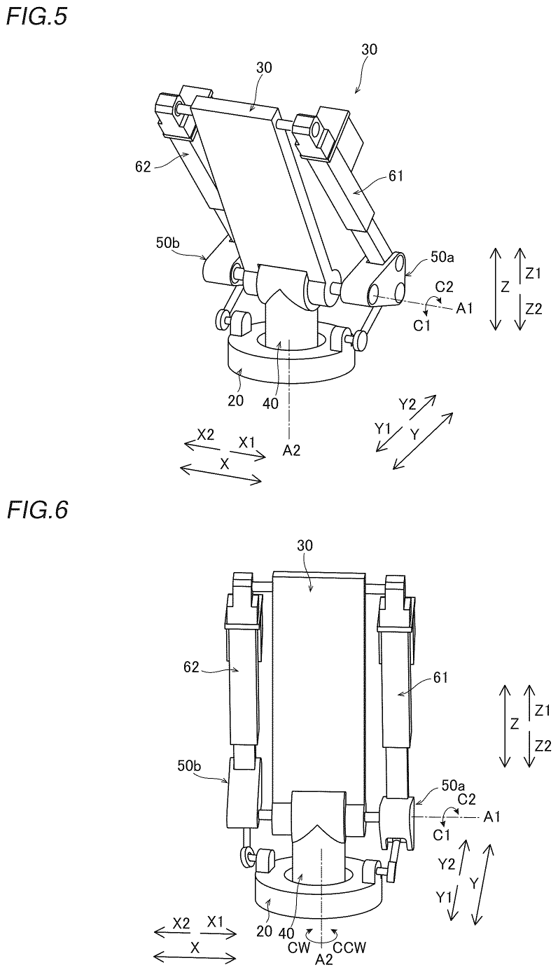

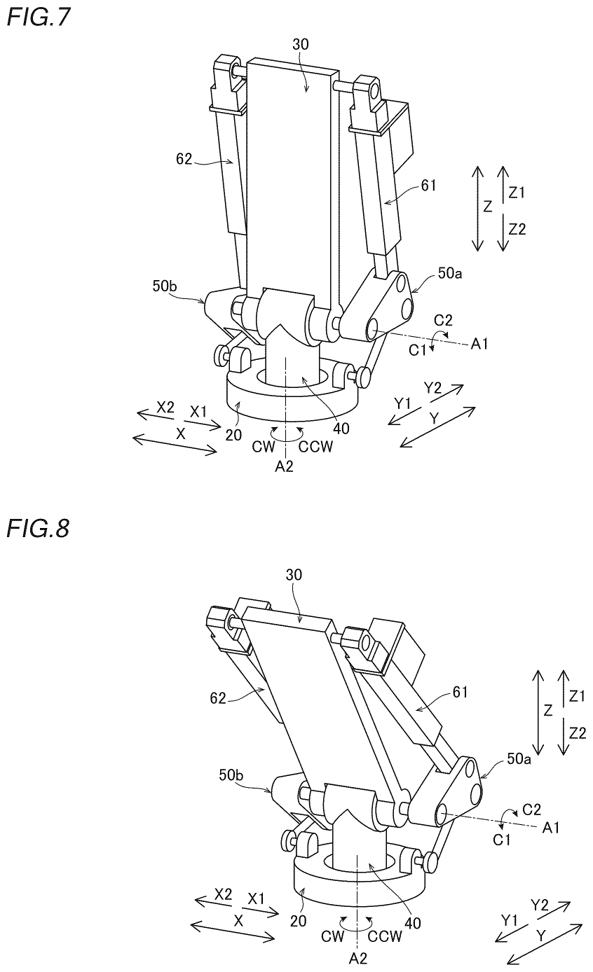

In this embodiment, as shown in FIG. 6, the second frame 30 is rotated relative to the first frame 20 about the yaw axis A2 by extending one selected from the group consisting of the first linear actuator 61 and the second linear actuator 62 and retracting another selected from the group consisting of the first linear actuator 61 and the second linear actuator 62 by the same length as an extension amount of the one selected from the group consisting of the first linear actuator 61 and the second linear actuator 62. For example, as shown in FIG. 6, the second frame 30 rotates the yaw axis A2 counterclockwise by extending the first linear actuator 61 and retracting the second linear actuator 62. Also, as shown in FIG. 7, the second frame 30 rotates the yaw axis A2 clockwise by retracting the first linear actuator 61 and extending the second linear actuator 62.

In this embodiment, as shown in FIG. 8, the second frame 30 is rotated relative to the first frame 20 about the pitch axis A1 and about the yaw axis A2, by holding one selected from the group consisting of the first linear actuator 61 and the second linear actuator 62 stationary (without extending or retracting) and extending another selected from the group consisting of the first linear actuator 61 and the second linear actuator 62. For example, the second frame 30 is rotated toward the C1 side about the pitch axis A1 and rotates the yaw axis A2 clockwise by holding the first linear actuator 61 stationary (without extending or retracting) and extending the second linear actuator 62. Also, the second frame 30 is rotated relative to the first frame 20 about the pitch axis A1 and about the yaw axis A2 by extending/retracting the first linear actuator 61 and the second linear actuator 62 in the same extension/retraction direction but by different extension/retraction amounts. Also, the second frame 30 is rotated relative to the first frame 20 about the pitch axis A1 and about the yaw axis A2 by extending one selected from the group consisting of the first linear actuator 61 and the second linear actuator 62 and retracting the other in the opposite directions and by different amounts.

### Advantages of the Embodiment

The waist joint 10 includes a first link mechanism 50a that is configured rotatably about the pitch axis A1 and is rotatably connected to the first frame 20 and the another end of the first linear actuator 61; and a second link mechanism 50b that is configured rotatably about the pitch axis A1 and is rotatably connected to the first frame 20 and the another end of the second linear actuator 62. Accordingly, because the first linear actuator 61 and the second linear actuator 62 are connected through the first link mechanism 50a and the second link mechanism 50b, respectively, to the first frame 20, the first linear actuator 61 and the second linear actuator 62 can be connected through the first link mechanism 50a and the second link mechanism 50b, respectively, to the first frame 20 without being arranged from the first frame 20 over the second frame 30. For this reason, the first linear actuator 61 and the second linear actuator 62 can be made smaller. Consequently, an increase in the size of the waist joint 10 of the humanoid robot 100 can be prevented.

Each of the first link mechanism 50a and the second link mechanism 50b includes a first link 51 having one end rotatably connected to the second frame 30, and a second link 52 having one end rotatably connected to the first link 51 and another end rotatably connected to the first frame 20. The one end of the first linear actuator 61 is rotatably connected to the second frame 30, and the another end of the first linear actuator is rotatably connected to another end of the first link 51. The one end of the second linear actuator 62 is rotatably connected to the second frame 30, and the another end of the first linear actuator is rotatably connected to another end of the first link 51. Accordingly, when the first linear actuator 61 is extended/retracted, the first frame 20 can be rotated about the yaw axis A2 by the second link 52, using the one end of the first link 51, which is rotatably connected to the second frame 30, as a fulcrum. The same applies when the second linear actuator 62 is extended/retracted.

Each of the first linear actuator 61 and the second linear actuator 62 is connected to a part on the another end of the first link 51 away from the first frame 20, and the second link 52 is connected to a part on the another end of the first link 51 closer to the first frame 20. Accordingly, since the parts of the first linear actuator 61 and the second linear actuator 62 that are connected to the first link 51 are spaced away from the part of the second link 52 that is connected to the first link 51, interference between the first and second linear actuators 61 and 62 and the second link 52 can be prevented.

The second frame 30 is rotated relative to the first frame 20 about the pitch axis A1 by extending the first linear actuator 61 and the second linear actuator 62 by the same length. Correspondingly, the upper torso 2 of the humanoid robot 100 can be inclined forward or backward.

The second frame 30 is rotated relative to the first frame 20 about the yaw axis A2 by extending one selected from the group consisting of the first linear actuator 61 and the second linear actuator 62 and retracting another selected from the group consisting of the first linear actuator 61 and the second linear actuator 62 by the same length as an extension amount of the one selected from the group consisting of the first linear actuator 61 and the second linear actuator 62. Correspondingly, the upper torso 2 of the humanoid robot 100 can be rotated about the yaw axis A2.

The second frame 30 is rotated relative to the first frame 20 about the pitch axis A1 and about the yaw axis A2, by holding one selected from the group consisting of the first linear actuator 61 and the second linear actuator 62 stationary (without extending or retracting) and extending another selected from the group consisting of the first linear actuator 61 and the second linear actuator 62. Correspondingly, the upper torso 2 of the humanoid robot 100 can be rotated about the yaw axis A2 while being inclined forward or backward.

The waist joint 10 functions as the waist joint 10 of the humanoid robot 100. Consequently, it is possible to prevent an increase in the size of the humanoid robot 100.

### Modified Embodiments

Note that the embodiment disclosed this time must be considered as illustrative in all points and not restrictive. The scope of the present disclosure is not shown by the above description of the embodiments but by the scope of claims for patent, and all modifications (modified embodiments) within the meaning and scope equivalent to the scope of claims for patent are further included.

While the example in which each of the first link mechanism 50a and the second link mechanism 50b includes the first link 51 and the second link 52 has been shown in the aforementioned embodiment, the present disclosure is not limited to this. For example, each of the first link mechanism 50a and the second link mechanism 50b may include three or more links.

Also, while the example in which each of the first linear actuator 61 and the second linear actuator 62 is connected to a part on the another end of the first link 51 away from the first frame 20, and the second link 52 is connected to a part on the another end of the first link 51 closer to the first frame 20 has been shown in the aforementioned embodiment, the present disclosure is not limited to this. For example, each of the first linear actuator 61 and the second linear actuator 62 and the second link 52 may be rotatably connected to an identical part of the first link 51.

Also, while the example in which the bearings 70 are arranged between the support 40 and the first frame 20 has been shown in the aforementioned embodiment, the present disclosure is not limited to this. For example, the support 40 and the first frame 20 may be in contact with each other to allow the first frame 20 to slide relative to the support 40.

Also, while the example in which the present disclosure is applied to the waist joint 10 of the humanoid robot 100 has been shown in the aforementioned embodiment, the present disclosure is not limited to this. For example, the present disclosure may be applied to the neck joint 8 and the wrist joints 15 of the humanoid robot 100. In this case, the neck joint 8 and the wrist joints 15 are examples of the joint structure. Also, the present disclosure may be applied to the ankle joints 13 of the humanoid robot 100. Also, the present disclosure may be applied to a joint of a robot other than the humanoid robot 100.

### Modes

The aforementioned exemplary embodiment will be understood as concrete examples of the following modes by those skilled in the art.

### Mode 1

A robot joint structure includes a first frame and a second frame; a support that rotatably supports the second frame about a first axis, the support being rotatably supported by the first frame about a second axis perpendicular to the first axis; a first linear actuator and a second linear actuator, each of which having one end connected to a corresponding one of both sides of the second frame and another end operating to extend/retract; a first link mechanism that is configured rotatably about the first axis and is rotatably connected to the first frame and the another end of the first linear actuator; and a second link mechanism that is configured rotatably about the first axis and is rotatably connected to the first frame and the another end of the second linear actuator.

### Mode 2

In the robot joint structure according to mode 1, each of the first link mechanism and the second link mechanism includes a first link having one end rotatably connected to the second frame, and a second link having one end rotatably connected to the first link and another end rotatably connected to the first frame; the one end of the first linear actuator is rotatably connected to the second frame, and the another end of the first linear actuator is rotatably connected to another end of the first link; and the one end of the second linear actuator is rotatably connected to the second frame, and the another end of the second linear actuator is rotatably connected to the another end of the first link.

### Mode 3

In the robot joint structure according to mode 2, each of the first linear actuator and the second linear actuator is connected to a part on the another end of the first link away from the first frame; and the second link is connected to a part on the another end of the first link closer to the first frame.

### Mode 4

In the robot joint structure according to any of modes 1 to 3, the second frame is rotated relative to the first frame about the first axis by extending the first linear actuator and the second linear actuator by an identical length.

### Mode 5

In the robot joint structure according to any of modes 1 to 4, the second frame is rotated relative to the first frame about the second axis by extending one selected from the group consisting of the first linear actuator and the second linear actuator and retracting another selected from the group consisting of the first linear actuator and the second linear actuator by an identical length to an extension amount of the one selected from the group consisting of the first linear actuator and the second linear actuator.

### Mode 6

In the robot joint structure according to any of modes 1 to 5, the second frame is rotated relative to the first frame about the first axis relative and about the second axis by holding one selected from the group consisting of the first linear actuator and the second linear actuator stationary, without extending or retracting, and extending another selected from the group consisting of the first linear actuator and the second linear actuator.

### Mode 7

In the robot joint structure according to any of modes 1 to 6, the joint structure includes at least one of a waist joint, a neck joint or a wrist joint of a robot.

### Mode 8

A robot includes a joint structure that forms at least one of a waist joint, a neck joint or a wrist joint, wherein the joint structure includes a first frame and a second frame, a support that rotatably supports the second frame about a first axis, the support being rotatably supported by the first frame about a second axis perpendicular to the first axis; a first linear actuator and a second linear actuator, each of which having one end connected to a corresponding one of both sides of the second frame and another end operating to extend/retract, a first link mechanism that is configured rotatably about the first axis and is rotatably connected to the first frame and the another end of the first linear actuator; and a second link mechanism that is configured rotatably about the first axis and is rotatably connected to the first frame and the another end of the second linear actuator.

1. A robot joint structure comprising:
a first frame and a second frame;
a support that rotatably supports the second frame about a first axis, the support being rotatably supported by the first frame about a second axis perpendicular to the first axis;
a first linear actuator and a second linear actuator, each of which having one end connected to a corresponding one of both sides of the second frame and another end operating to extend/retract;
a first link mechanism that is configured rotatably about the first axis and is rotatably connected to the first frame and the another end of the first linear actuator; and
a second link mechanism that is configured rotatably about the first axis and is rotatably connected to the first frame and the another end of the second linear actuator.

2. The robot joint structure according to claim 1, wherein
each of the first link mechanism and the second link mechanism includes a first link having one end rotatably connected to the second frame, and a second link having one end rotatably connected to the first link and another end rotatably connected to the first frame;
the one end of the first linear actuator is rotatably connected to the second frame, and the another end of the first linear actuator is rotatably connected to another end of the first link; and
the one end of the second linear actuator is rotatably connected to the second frame, and the another end of the second linear actuator is rotatably connected to the another end of the first link.

3. The robot joint structure according to claim 2, wherein
each of the first linear actuator and the second linear actuator is connected to a part on the another end of the first link away from the first frame; and
the second link is connected to a part on the another end of the first link closer to the first frame.

4. The robot joint structure according to claim 1, wherein the second frame is rotated relative to the first frame about the first axis by extending the first linear actuator and the second linear actuator by an identical length.

5. The robot joint structure according to claim 1, wherein the second frame is rotated relative to the first frame about the second axis by extending one selected from the group consisting of the first linear actuator and the second linear actuator and retracting another selected from the group consisting of the first linear actuator and the second linear actuator by an identical length to an extension amount of the one selected from the group consisting of the first linear actuator and the second linear actuator.

6. The robot joint structure according to claim 1, wherein the second frame is rotated relative to the first frame about the first axis relative and about the second axis by holding one selected from the group consisting of the first linear actuator and the second linear actuator stationary, without extending or retracting, and extending another selected from the group consisting of the first linear actuator and the second linear actuator.

7. The robot joint structure according to claim 1, wherein the joint structure includes at least one of a waist joint, a neck joint or a wrist joint of a robot.

8. A robot comprising a joint structure that forms at least one of a waist joint, a neck joint or a wrist joint, wherein
the joint structure includes
a first frame and a second frame,
a support that rotatably supports the second frame about a first axis, the support being rotatably supported by the first frame about a second axis perpendicular to the first axis;
a first linear actuator and a second linear actuator, each of which having one end connected to a corresponding one of both sides of the second frame and another end operating to extend/retract,
a first link mechanism that is configured rotatably about the first axis and is rotatably connected to the first frame and the another end of the first linear actuator; and
a second link mechanism that is configured rotatably about the first axis and is rotatably connected to the first frame and the another end of the second linear actuator.
